(19) United States
(12) Patent Application Publication
(10) Pub. No.: US 2018/0018459 A1
(43) Pub. Date: Jan. 18, 2018

(54) Notification of Maliciousness Categorization of Application Programs for Mobile Devices

(71) Applicant: Trustlook Inc., San Jose, CA (US)

(72) Inventors: Liang Zhang, Pleasanton, CA (US); Jinjian Zhai, Union City, CA (US)

(21) Appl. No.: 15/211,989

(22) Filed: Jul. 15, 2016

(51) Int. Cl. G06F 21/56; G06F 9/445; G06F 21/55

(52) U.S. Cl. CPC G06F 21/566; G06F 21/554; G06F 8/62; G06F 2221/033

(57) ABSTRACT

An approach near instantly notifies devices onto which an application program is installed when the application program is identified as malware. An analysis system records application programs installed on devices. When an application program is identified as malware, the analysis system can locate a set of devices onto which the application program is installed. The analysis system notifies these devices near instantly when the particular application program is identified as malware. Users may be prompted to uninstall the application program from the devices. In addition, the devices may include instrumentations that block the application program from performing any malicious behavior. The application program may be identified as malware by malware detection methods that perform static and dynamic analysis of the application program on the analysis system or on mobile devices.

### BACKGROUND

### 1. Technical Field

The present invention relates generally to the field of application and data security and, more particularly, to the detection, classification, and notification of malware.

### 2. Background Information

The ubiquity of electronic devices, particularly mobile devices, is an ever-growing opportunity for cybercriminals and hackers who use malicious software (malware) to invade users' personal lives, to develop potentially unwanted applications (PUA) such as riskware, pornware, risky payment apps, hacktool and adware, and to bring unpleasant experience in smart phone usage. Cybercriminals can use malware and PUA to disrupt the operation of mobile devices, display unwanted advertising, intercept messages and documents, monitor calls, steal personal and other valuable information, or even eavesdrop on personal communications. Examples of different types of malware include computer viruses, Trojans, rootkits, ransomware, bots, worms, spyware, scareware, exploit, shell, and packer. As the number of electronic devices and software applications for those devices grows, so do the number and types of vulnerability and the amount and variety of software that is hostile or intrusive. Malware can take the form of executable code, scripts, active content and other software. It can also be disguised as, or embedded in, non-executable files such as PNG files. In addition, as technology progresses at an ever faster pace, malware can increasingly create hundreds of thousands of infections in a period of time (e.g., as short as a few days).

Mobile devices often rely on signature based malware detection approaches to protect against malware. In that approach, signatures of malwares are known and the mobile device compares the signatures of its software to the known malware signatures. The signatures are typically determined outside the mobile device, for example by a more powerful cluster of backend servers, and then loaded to the mobile device. However, this approach usually compromises between efficiency and coverage and cannot offer comprehensive and efficient protection against malware. As the number of malwares grows, the number of malware signatures also grows and it can be computationally expensive for a mobile device to compare against all known malware signatures. It is also important to detect new types of malware as they are introduced into the technology ecosystem and to notify users onto whose mobile devices the malware has been installed. However, given technology trends, this task is becoming ever more difficult due to the increasing number and variety of devices, vulnerabilities and malware. Furthermore, it must be accomplished in ever shorter time periods due to the increasing speed with which malware can proliferate and cause damage.

### SUMMARY

An approach notifies devices onto which an application program is installed, near instantly upon identification of the application program as malware. After malware is released into the technology ecosystem, it may be installed on many devices before it is identified as malware. A fast notification approach can substantially minimize the damage caused by a malware, as the devices that have been installed with the malware can be notified very quickly when the malware is discovered. The devices can be protected from the malware almost at the same time that the malware is discovered.

In one approach, an analysis system records which application programs are installed on which devices. When an application program is identified as malware, the analysis system can locate a set of devices onto which the application program is installed. The analysis system near instantly notifies these devices when the particular application program is identified as malware. Users may be prompted to uninstall the application program from the devices. In addition, the devices may be configured to include instrumentations that block the application program from performing any malicious behavior. The application program may be identified as malware by security vulnerability detection methods that perform dynamic analysis of the application program on the analysis system or on mobile devices, for example.

Other aspects include components, devices, systems, improvements, methods, processes, applications, computer readable mediums, and other technologies related to any of the above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a high-level block diagram illustrating a technology environment that includes an analysis system that protects the environment against malware, according to one embodiment.

FIG. 2 is a high-level block diagram illustrating an analysis system for detecting security vulnerabilities, according to one embodiment.

FIG. 3 is a high-level block diagram illustrating a behavior observation module for generating behavior tokens, according to one embodiment.

FIG. 4A (prior art) is a block diagram illustrating architecture layers of a conventional mobile device.

FIG. 4B is a block diagram illustrating architecture layers of a client device, according to one embodiment.

FIGS. 5A-B are high-level block diagrams illustrating detecting security vulnerability as implemented on client devices, according to different embodiments.

FIG. 6 is a high-level block diagram illustrating a client device for detecting security vulnerabilities, according to one embodiment.

FIG. 7 is a flow chart illustrating a process of notifying devices of security vulnerabilities, according to one embodiment.

FIG. 8 is a high-level block diagram illustrating an example of a computer for use as one or more of the entities illustrated in FIG. 1, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

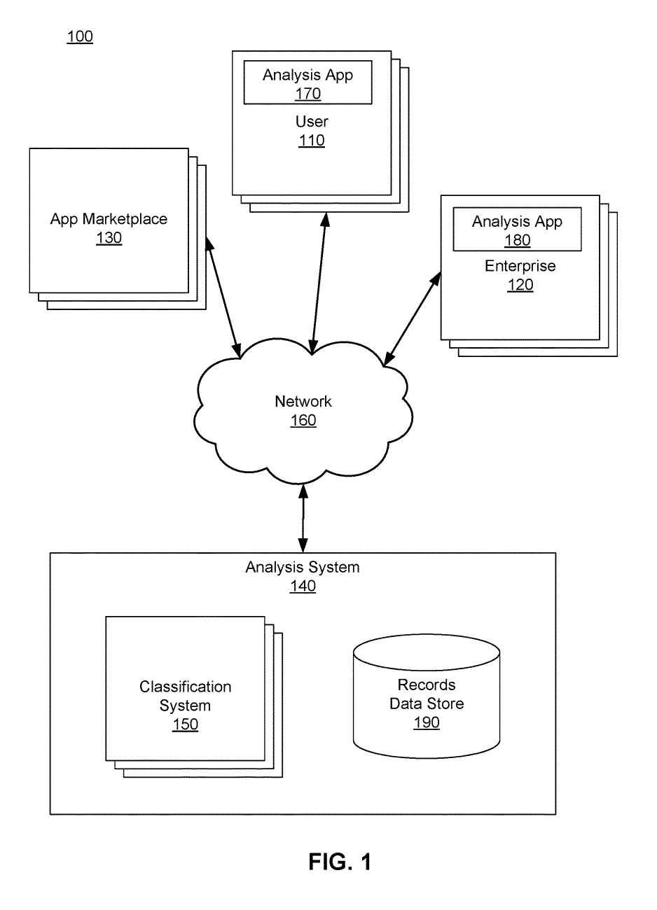

FIG. 1 is a high-level block diagram illustrating a technology environment 100 that includes an analysis system 140, which protects the environment against malware, according to one embodiment. The environment 100 also includes users 110, enterprises 120, application marketplaces 130, and a network 160. The network 160 connects the users 110, enterprises 120, app markets 130, and the analysis system 140. In this example, only one analysis system 140 is shown, but there may be multiple analysis systems or multiple instances of analysis systems. The analysis system 140 provides security vulnerabilities (e.g., malware, viruses, spyware, Trojans, etc.) detection services to the users 110. The users 110, via various electronic devices (not shown), receive security vulnerability such as malware detection results from the analysis system 140. The users 110 may interact with the analysis system 140 by visiting a website hosted by the analysis system 140. As an alternative, the users 110 may download and install a dedicated application to interact with the analysis system 140. The users 110 may download and install a dedicated application to interact with the analysis system 140. A user 110 may sign up to receive security vulnerability detection services such as receiving a comprehensive overall security score indicating whether a device or application or any file is safe or not, malware or virus scanning service, security monitoring service, and the like.

User devices include computing devices such as mobile devices (e.g., smartphones or tablets with operating systems such as Android or Apple IOS), laptop computers, wearable devices, desktop computers, smart automobiles or other vehicles, or any other type of network-enabled device that downloads, installs, and/or executes applications. A user device may query a detection Application program interface (“API”) and other security scanning APIs hosted by the analysis system 140. A user device may detect malware based on the local dynamic analysis engine embedded in an application installed in its read only memory (ROM). A user device typically includes hardware and software to connect to the network 160 (e.g., via Wi-Fi and/or Long Term Evolution (LTE) or other wireless telecommunication standards), and to receive input from the users 110. In addition to enabling a user to receive security vulnerability detection services from the analysis system 140, user devices may also provide the analysis system 140 with data about the status and use of user devices, such as their network identifiers and geographic locations.

The enterprises 120 also receive security vulnerabilities (e.g., malware, viruses, spyware, Trojans, etc.) detection services provided by the analysis system 140. Examples of enterprises 120 include corporations, universities, and government agencies. The enterprises 120 and their users may interact with the analysis system 140 in at least the same ways as the users 110, for example through a website hosted by the analysis system 140 or via dedicated applications installed on enterprise devices. Enterprises 120 may also interact in different ways. For example, a dedicated enterprise-wide application of the analysis system 140 may be installed to facilitate interaction between enterprise users 120 and the analysis system 140. Alternately, some or all of the analysis system 140 may be hosted by the enterprise 120. In addition to individual user devices described above, the enterprise 120 may also use enterprise-wide devices.

Application marketplaces 130 distribute application programs to users 110 and enterprises 120. An application marketplace 130 may be a digital distribution platform for mobile application software or other types of computer software. An application program publisher (e.g., developers, vendors, corporations, etc.) may release an application program package to the application marketplace 130. The application program package may be available for the public (i.e., all users 110 and enterprises 120) or specific users 110 and/or enterprises 120 selected by the software publisher for download and use. In one embodiment, the application being distributed by the application marketplace 130 is a software package in the format of Android application package (APK). Although the examples below refer to APKs, that is not a limitation. In other embodiments, the application being distributed may alternatively and/or additionally be software packages in other forms or file formats.

The analysis system 140 provides security vulnerabilities detection services, such as malware detection services, to users 110 and enterprises 120. The analysis system 140 detects security threats on the user devices of the users 100 as well as on the enterprise devices of the enterprises 120. The user devices and the enterprise devices are hereinafter referred together as the “client devices” and the users 110 and enterprises 120 as “clients”. In various embodiments, the analysis system 140 analyzes APKs of the application programs to detect malicious application programs. APKs of the application programs are identified by unique APK IDs, such as a hash of the APK. The analysis system 140 may notify a client of the malicious application programs installed on the client device. The analysis system 140 may notify a client when determining that the client is attempting to install or has installed a malicious application program on the client device. The analysis system 140 analyzes new and existing APKs. New APKs are APKs that are not known to the analysis system 140 and for which the analysis system 140 does not yet know whether the APK is malware. Existing APKs are APKs that are already known to the analysis system 140. For example, they may have been previously analyzed by the analysis system 140 or they may have been previously identified to the analysis system 140 by a third party, for example, using other signature based detection modules.

If the APK is new to the analysis system 140, the analysis system 140 analyzes the new application program to determine whether it is malware or other security vulnerability. The analysis system 140 receives new APKs in a number of ways. As one example, the dedicated application of the analysis system 140 that is installed on a client device (e.g., analysis apps 170 and 180) identifies new APKs and provides them to the analysis system 140. As another example, the analysis system 140 periodically crawls the app marketplace 130 for new APKs. As a further example, the app marketplace 130 periodically provides new APKs to the analysis system 140, for example, through automatic channels.

For existing APKs, the analysis system 140 may apply regression testing to verify analysis of existing APKs. New models may be applied to analyze existing APKs to verify detection of malware and other security vulnerability. For example, the analysis system 140 may over time be enhanced with the ability to detect more malicious behaviors. Thus, the analysis system 140 analyzes the existing APKs that have been analyzed previously to identify whether any of the existing APKs that were detected to be benign are in fact malicious, or vice versa.

The analysis system 140 includes one or more classification systems 150 that may apply different techniques to classify an APK. For example, a classification system 150 analyzes system logs of an APK to detect malicious codes thereby to classify the APK. As another example, a classification system 150 traces execution of the application such as control flows and/or data flows to detect anomalous behavior thereby to classify an APK. The analysis system 140 maintains a list of identified malicious APKs.

The network 160 is the communication pathway between the users 110, enterprises 120, application marketplaces 130, and the analysis system 140. In one embodiment, the network 160 uses standard communications technologies and/or protocols and can include the Internet. Thus, the network 160 can include links using technologies such as Ethernet, 802.11, InfiniBand, PCI Express Advanced Switching, etc. Similarly, the networking protocols used on the network 160 can include multiprotocol label switching (MPLS), transmission control protocol/Internet protocol (TCP/IP), User Datagram Protocol (UDP), hypertext transport protocol (HTTP) and secure hypertext transport protocol (HTTPS), simple mail transfer protocol (SMTP), file transfer protocol (FTP), etc. The data exchanged over the network 160 can be represented using technologies and/or formats including image data in binary form (e.g., Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities on the network 160 can use custom and/or dedicated data communications technologies instead of, or in addition to, the ones described above.

The analysis applications 170 and 180 are dedicated apps installed on a user device and an enterprise device, respectively. When installing an APK, the analysis application 170 or 180 compares the APK ID to the analysis results from the analysis system 140. The analysis results include malicious applications that are identified by the APK IDs. If the new APK ID matches the APK ID of a known malicious APK, the analysis application 170 or 180 alerts the user of the security threat and/or takes other appropriate action. For convenience, the description that follows is made with respect to the analysis application 170, but it should be understood that the description also applies to analysis application 180.

The analysis system 140 creates and maintains records of application programs installed on all client devices. The analysis system 140 includes a records data store 190 that stores records of application programs installed on client devices. For each client device, the analysis system 140 creates and maintains a list of application programs installed on the client device. For each client device, the analysis system 140 creates and updates an installation record that stores information related to client application programs installed on the client device. When the analysis application 170 is installed on a client device, the client device sends information related to all application programs installed on the client device to the analysis system 140. The analysis application 170 may query the application programs installed on the client device, for example, by interacting with the operating system of the client device. In one embodiment, the analysis application 170 may interface with the Android application program interface (“API”) to obtain a list of application programs installed on the client device. The analysis system 140 hashes an application program to determine the application program ID associated with the application program.

The analysis system 140 creates an installation record for the client device according to the received information. Example information includes the client device's device ID (e.g., unique device identifier (UDID)), the client device's IP address, the client device's MAC address, application program package IDs (e.g., APK ID) associated with the application programs, package names of the application programs, user information associated with the client device (e.g., Google mobile service (GMS) ID, telephone number, email address, etc.), and the like. A location of the client device at a particular time point may be determined from the IP address and/or the MAC address of the client device at the particular time point. When a user installs (or uninstalls) an application program onto a client device, the analysis application 170 sends information related to the particular application program being installed (or uninstalled) to the analysis system 140. The analysis application 140 may interface with the operating system of the client device to detect that an application program is installed (or uninstalled) on the client device. For example, in response to the user installing (or uninstalling) the application program of the client device, the operating system of the client device may broadcast a message on the client device. In response to receiving the message, the analysis application 170 identifies that the application program has been installed (or uninstalled) on the client device. Based on the received information, the analysis system 140 identifies and updates the installation record for the particular client device to include (or remove) the particular application program.

The information related to installation (or uninstallation) of a particular application program may be sent unsuccessfully due to various reasons, for example, when there is no network connection. In these situations, the analysis application 170 may attempt to resend the information periodically (e.g., 5 seconds or a user configured time period) until the information is successfully sent to the analysis system 140. Alternatively, the analysis application 170 may track the application programs that are installed and uninstalled during the time period when there is no network connection, and sends the information related to the application programs installed and uninstalled during the time period to the analysis system 140 when the network connection is restored. The installation records stored in the records data store 190 may be indexed by device IDs or application program IDs. In addition, the analysis system 140 may further associate and store the category (e.g., malicious or benign) of an application program in an installation record.

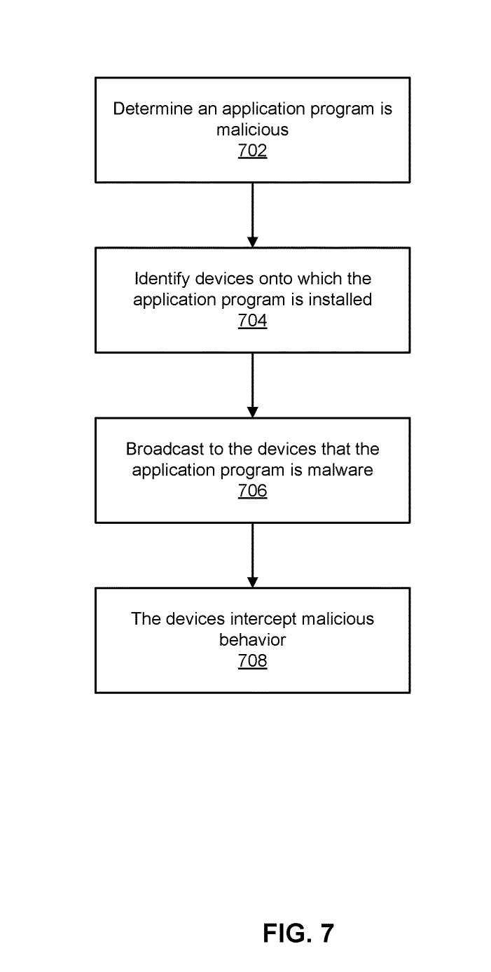

When the analysis system 140 identifies an application program as malware, the analysis system 140 can near instantly notify client devices onto which the particular application program is installed. The analysis system 140 can identify the client devices that need to be notified within a first time interval after an application is identified as malware. The first time interval is typically less than a few minutes (e.g., 1-3 minutes). After the analysis system 140 identifies the client devices that need to be notified, the analysis system 140 may notify the client devices within a second time interval. The second time interval is typically less than a few seconds (e.g., one second). The analysis system 140 may further update installation records accordingly. Based on the application program package ID of the particular application program, the analysis system 140 looks up installation records that include the particular application program ID and the corresponding client devices' IDs. The analysis system 140 can notify the client devices corresponding to the identified client devices' IDs or GMS IDs that the particular application program is malware. The analysis system 140 can notify users of the client devices, for example, via notifications such as pop-up messages via the analysis application 170 installed on the client devices, and the like. Furthermore, some or all client devices can prevent application programs from performing malicious behavior as further described below with respect to FIG. 7.

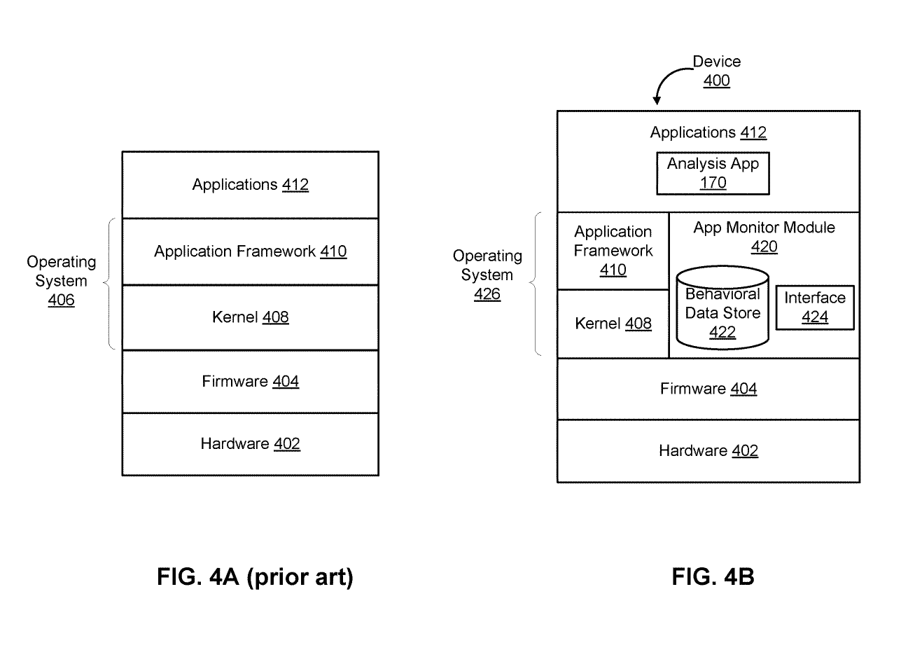

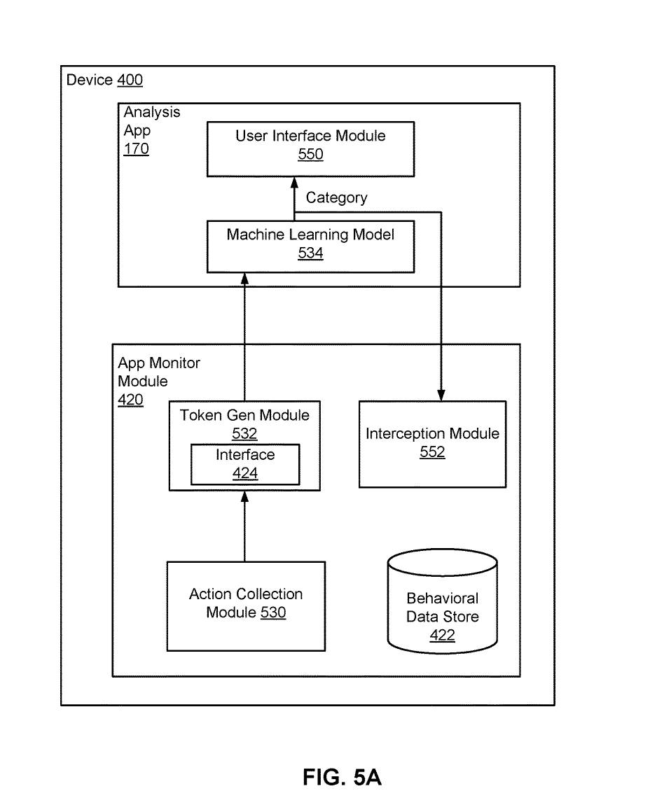

When client devices are offline and there is no communication between the analysis system 140 and the client devices, the client devices can no longer receive protection against security vulnerabilities from the analysis system 140. The client devices can still detect malware and other security vulnerabilities, for example by analyzing behaviors of applications on-device. In the following examples, the analysis is based on machine learning models. The machine learning models running on the client device are provided by the analysis system 140. They may be machine learning models that result from training of the analysis system 140. The machine learning models may be installed on the client device when the analysis application 170 is installed or updated on the client device. The analysis app 170, in conjunction with additional software/hardware on the device, may identify malware and other security vulnerabilities by observing and analyzing the behavior of the application program. The analysis app 170 may further intercept malicious behavior or report malicious application programs thereby to prevent damage. Details of examples of on-device detection of malware and other security vulnerabilities are provided with respect to FIGS. 4B through 6.

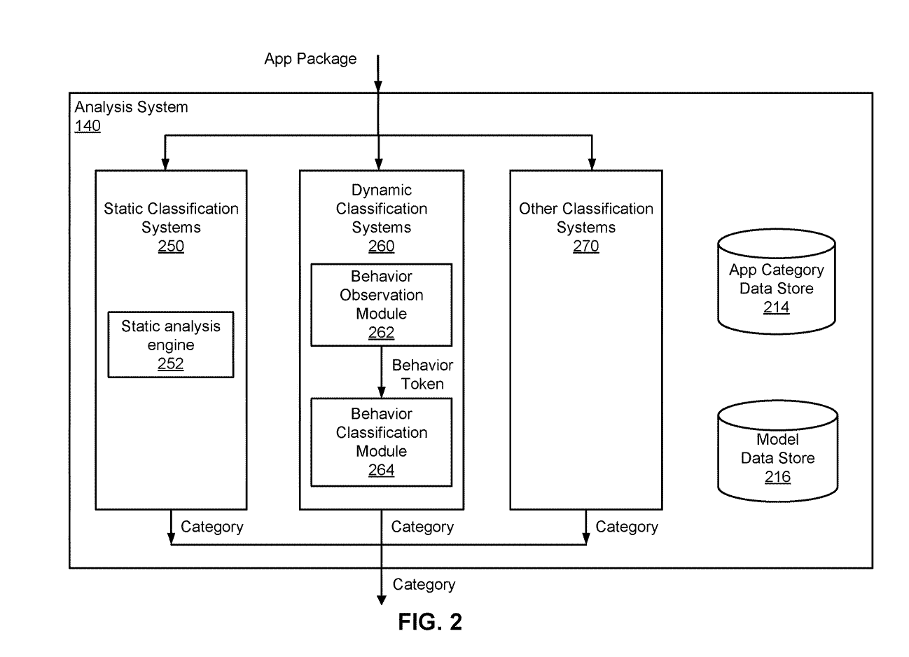

FIG. 2 is a high-level block diagram illustrating an analysis system 140 for detecting security vulnerabilities, according to one embodiment. The analysis system 140 stores and maintains prior analysis results of the APKs in the app category data store 214. Each application is identified by the APK ID and associated with a category (e.g., malicious or benign) classified by the analysis system 140. An application may be further associated with metadata (e.g., version, release time, etc.) If the APK ID of the received software package cannot be located in the list, then it is a new APK to be analyzed. The software application package is classified by one or more classification systems 250, 260, 270 included in the analysis system 140. Each classification system classifies the software application package into a category (e.g., benign or malicious). In this example, the classification systems include static classification systems 250 and dynamic classification systems 260. One of ordinary skill in the art would appreciate that the analysis system 140 can include classification systems 270 that use other techniques to classify an application. The categorizations from the different classification systems are combined to produce an overall category for the application.

The static classification system 250 classifies a software application package as benign or malicious by using a static analysis of the software application package. The static classification system 250 includes one or more static analysis engines 252 that analyze the object code of the software application package. A static analysis engine 252 analyzes the functionality and structure of the APK based on the static object code. For example, the binary code is decompiled. The entire decompiled binary code or a portion thereof is compared to codes that are identified to be malicious or benign to determine if the binary code is malicious or benign. One or more trained machine learning models may be used to compare the binary codes to known malicious or benign binary codes. A static analysis engine 252 may check for developer certificate signatures, malicious keywords in strings of binary codes, URLs, malicious domain names, known functions calls used in malware, sections of mobile application machine codes or other features of known malicious codes. A static analysis engine 252 may parse the binary code to identify different software components, and then analyze the software components and their functionality and structure for maliciousness or vulnerability.

The dynamic classification system 260 classifies a software application package as benign or malicious based on behavioral analysis. That is, the dynamic classification system 260 analyzes behavior of the application on a client device to classify a software application package. The dynamic classification system 260 includes a behavior observation module 262 and a behavior analysis module 264, which is implemented using machine learning. The dynamic classification system 260 categorizes an application based on the behavior of the application when it is executed. The behavior observation module 262 observes the behavior of the executing application, and the behavior analysis module 264 determines whether this behavior is benign or malicious. The determination may be a sliding scale, such as a confidence level that the behavior is either benign or malicious, or may be a binary decision of either benign or malicious.

The behavior observation module 262 provides a sandbox environment in which an application program is executed and monitored. The behavior observation module 262 observes the behavior and generates a representation of the behavior. In this example, the behavior is represented by a behavior token. The behavior observation module 262 exercises the application to determine whether the application exhibits the behaviors.

The behavior analysis module 264 classifies the application based on the behavior token. The behavior analysis module 264 uses one or more artificial intelligence models, classifiers, or other machine learning models to classify an application using the behavior token of the application. These models are stored in the model data store 216.

An artificial intelligence model, classifier, or machine learning model is created, for example, by the behavior analysis module 264 to determine correlations between behavior features and categories of applications. In one embodiment, the machine learning models describes correlations between categories of applications and behavior features. Using the behavior token generated for an application, the behavior analysis module 264 identifies the category that is more correlated to the behavior features presented by the software application package.

The machine learning models created and used by the behavior analysis module 264 may include, but are not limited to, regression, support vector machine (SVM), decision trees, and neural network classifiers. The machine learning models created by the behavior analysis module 264 includes model parameters that determine mappings from behavior features of an application to a category of the application (e.g., malicious or benign). For example, model parameters of a logistic classifier include the coefficients of the logistic function that correspond to different behavior features. As another example, the machine learning models created by the behavior analysis module 264 include a SVM model, which is a hyperplane or set of hyperplanes that is farthest away from any data point of different categories. Kernels are selected such that initial test results can be obtained within a predetermined time frame and tuned to improve detection rates. Initial sets of parameters can be selected based on most comprehensive description of known malware.

The machine learning models used by the behavior analysis module 264 analyze behavior features to identify which behavioral features or combinations thereof can be used to distinguish benign and malicious behavior. The behavior analysis module 264 creates machine learning models (e.g., determines the model parameters) by using training data. The training data includes behavior tokens and the corresponding categories for previously analyzed applications. This can be arranged as a table, where each row includes the behavior token and category for a different application. Based on this training data, the behavior analysis module 264 determines the model parameters for a machine learning model that can be used to predict the category of an application.

After classifying a new software application package, the behavior analysis module 264 includes the behavior token and determined category in the training data. The behavior analysis module 264 may also update machine learning models (e.g., model parameters) using input received from a system administrator or other sources. The system administrator can classify a software application package or overwrite a category of a software application package classified by the analysis system, for example if more reliable information is received from another source. The system administrator may further provide one or more behavior features that are associated with the category of the software application package. The behavior analysis module 264 includes this information in the training data to create new machine learning models or update existing machine learning models.

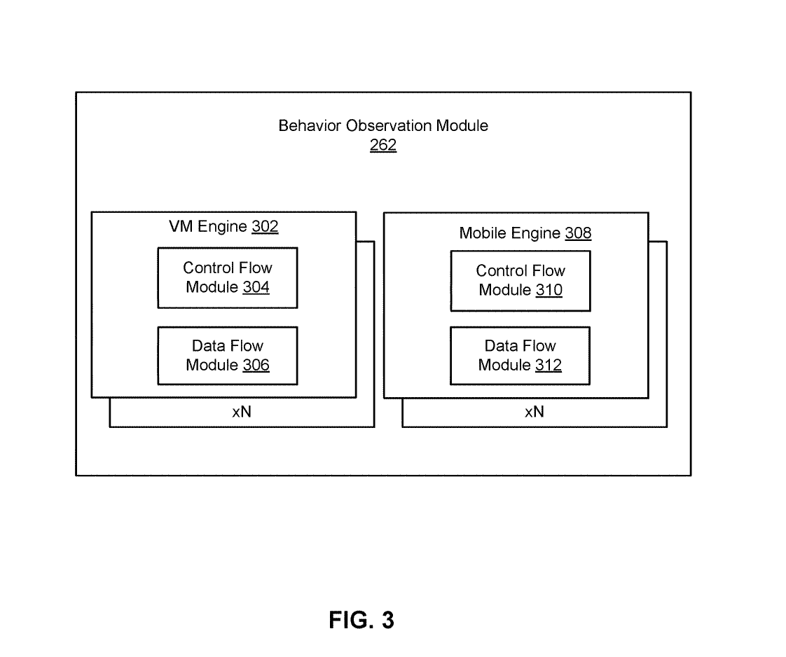

FIG. 3 is a high-level block diagram illustrating a behavior observation module 262 for generating behavior tokens of software application packages, according to one embodiment. The behavior observation module 262 includes instrumented simulation engines for the client devices, which allow the instrumented simulation of client devices. In this example, there are one or more virtual machine (“VM”) engines 302 for computer-like devices, such as laptops and tablets, and one or more mobile engines 308 for lighter weight mobile devices, such as smart phones. A VM engine 302 is a computing system that simulates a client device. For example, the VM engine 302 simulates the architecture and functions of a client device, but it includes additional code (instrumentation) so that the desired behaviors can be observed. The VM engine 302 thereby provides the sandbox or safe run environment in which a software application package operates as if the software application package is operating in the client device that the VM engine 302 emulates. In some embodiments, ROMs of computing systems are configured to include operating systems and user or data images. As such, VM engines 302 can capture and monitor all behavior of an application. A particular software application package may behave differently in different client devices because the different client devices have different hardware architectures and are installed with different operating systems or various versions of an operating system. Accordingly, the behavior observation module 262 includes multiple VM engines 302 to emulate different client devices such that behavior of a software application package on the different client devices can be captured.

In this example, the VM engine 302 includes a control flow module 304 and a data flow module 306. These are two types of dynamic analysis. The control flow module 304 generates a control flow graph of a software application package that includes paths traversed by the corresponding application during its execution. This control flow graph can be analyzed to determine whether certain behaviors have occurred. In a control flow graph, each node represents a basic block. A basic block is a straight-line piece of or a small section of code from the source code building the operating system binary image. The basic block may reveal the actions an application calls in its activity or service and can be used to trace the control flow inside a complied application binary package. The control flow graph therefore can be analyzed to reveal dependencies among basic blocks. As such, a software application package in which malicious code is hidden and cannot be detected by the static analysis engine 206 can be detected because the malicious behavior can be detected by analyzing the control flow graph. For example, any application that uses packer services to encrypt their code can be detected. As one example, an event of sending SMSs to all contacts stored in a device that is automatically triggered by an event of accessing all contacts stored in the device can be uncovered by analyzing a control flow graph of a software application package. As another example, uninstalling and installing an application without a user's permission in the background can be uncovered by analyzing a control flow graph of a software application package.

The data flow module 306 generates flows of data, such as sensitive data, from a data source from which the application obtains the data to a data sink to which the application writes the data. The data source and the data sink are external to the application and the data flows may include intermediate components that are internal to the application. For example, the data source is a memory of a device and the data sink is a network API. Examples of other data sources include input devices such as microphones, cameras, fingerprint sensors, chips, and the like. Examples of other data sinks include speakers, Bluetooth transceivers, vibration actuators, and the like. Different types of information flows between sources and sinks.

The data flow module 306 generates data flows that include behavior features at sufficiently precisions for various types of data sources and data sinks. For example, the generated data flow for a file data source includes information such as file name and user name, and the generated data flow for a network data sink includes information such as IP addresses, SSL certificates, and URLs. Any data of interest can be tagged and the data flow can be tracked across the operating system. As one example, telephone numbers and SMSs can be tagged as sensitive data to detect applications that subscribe paid services on users' expenses. SMSs can be intercepted after paid services are subscribed and the paid service is detected from the service number. The data flows can be analyzed for data that are tracked in the behavior token. Data flows as a result of execution of an application can be used to detect several types of behavior that leaks privacy. For example, an application accessing sensitive information that should not be accessed by the application can be detected. As another example, an application that sends sensitive information to a data sink that is not authorized to receive it can be detected. As a further example, an application that receives data from an untrusted website and writes it to a file meant to hold trustworthy information can be detected.

While the control flow module 304 and the data flow module 306 are described independently above, the control flow module 304 and the data flow module 306 can collaborate to generate the behavior token. For example, the data flow module 306 may generate data flows while the control flow graph is being generated by the control flow module 304 such that the control flow graph includes the data flows. The data flow module 306 can detect a basic block that behaves suspiciously, and the control flow module 304 can confirm that this basic block is regularly exercised.

A mobile engine 308 is a computing system that executes applications on mobile devices. In one embodiment, the mobile engine 308 is run on a mobile phone. The mobile engine 308 includes a control flow module 310 and a data flow module 312. Similar to the control flow module 304, the control flow module 310 generates control flow graphs of a software application package. Similar to the data flow module 306, the data flow module 312 generates data flows of a software application package.

The VM engines 302 and mobile engines 308 facilitate high throughput, flexible, unpolluted user scenario execution by automatically provisioning different ROMs, and initializing applications and data to a defined initial state with preset data and cache of ordinary users. The VM engines 302 and mobile engines 308 ensure that the control flow modules 304 and 310 as well as data flow modules 306 and 312 observe the execution paths of interest by supplying appropriate user input, and collect the output from the control flow modules 304 and 310 and also data flow modules 306 and 312 across managed physical mobile devices.

Compared to mobile engines 308, VM engines 302 can be more cost-efficient than mobile devices because the server hosting VM engines can be used to emulate different client devices, reducing the capital expenditure needed to acquire a given variety of client devices. In addition, VM engines 302 can be more easily configured and managed. A control flow module or data flow module can be more easily implemented on a VM engine 302 because the emulation can be developed by targeting a specific phone type of which an emulator can be easily accessed, whereas a specific mobile device is limited to the production lifetime and existence of hardware.

FIG. 4A (prior art) is a block diagram illustrating architecture layers of a conventional mobile device, such as a mobile phone. The mobile device includes a hardware layer 402, a firmware layer 404, an operating system 406 that includes a kernel layer 408 and an application framework layer 410, and an applications layer 412. The hardware layer 402 includes a collection of physical components such as one or more processors, memories (e.g., read only memory (ROM), random access memory (RAM)), circuit boards, antennas, cameras, speakers, sensors, Global Positioning Systems (GPSs), Light Emitting Diodes (LEDs), and the like. The physical components are interconnected and execute instructions. The firmware layer 404 includes firmware that provides control, monitoring and data manipulation of the hardware layer 402. Firmware usually resides in the ROM.

The operating system 406 is system software that manages hardware and software resources of the mobile device and provides common services for computer programs such as application programs on the applications layer 412. The kernel layer 408 includes computer program that constitutes the central core of the operating system 406. For example, the kernel layer 108 manages input/output requests from software and translates them into data processing instructions for the processor, manages memories, manages and communicates with computing peripheral hardware such as cameras, and the like. On top of the kernel layer 408 is the application framework layer 410 that includes a software framework that provides generic functionality that can be selectively changed by additional code. Software frameworks may include support programs, compliers, code libraries, tool sets, and application programming interfaces (APIs). The applications layer 412 includes application programs that are designed to perform various functions, tasks, or activities.

FIG. 4B is a block diagram illustrating architecture layers of a client device 400 including on-device malware and other security vulnerability detection through behavioral analysis, according to one embodiment. The operating system layer 426 is modified to include additional instrumentation (e.g., an application monitor module 420) that allows a wider range of behavior to be observed than on a conventional mobile device. Compared to the conventional mobile device illustrated in FIG. 4A, the client device additionally includes an application monitor module 420. Compared to the operating system layer 406 of the conventional mobile device illustrated in FIG. 4A, the operating system layer 426 includes the application monitor module 420 that augments the application framework layer 410 and the kernel layer 408 such that execution of an application program can be monitored and recorded on the client device 400. Behavior of a given application program at the hardware layer 402, at the kernel layer 408, at the application framework layer 410, and at the applications layer 412 can be monitored and recorded. The operating system 426 provides an environment in which an application program operates as if the application program is operating on a conventional mobile device as illustrated in FIG. 4A that does not include the application monitor module 420. That is, the modification on the client device is preferably agnostic to the application program and does not affect the behavior of the application program. In various embodiments, source code of the application monitor module 420 is included in the source code of the operating system 426. In some embodiments, ROMs of the client device 400 are configured to include the instrumented operating system.

The application monitor module 420 includes a behavioral data store 422 and an interface module 424. The behavioral data store 422 stores information related to execution of an application program at one or more layers. In some embodiments, the application program logs execution information in the behavioral data store 422 during its execution on the client device 400. Example execution information of an application program includes process information, memory information, job status, package name, metadata of the application program, timestamps, behavior such as tokenized behavior description, detailed information of behavior, and the like. In one embodiment, information related to execution of application programs is stored in a SQL database. In some embodiments, the application monitor module 420 accesses the memory, hardware APIs, and/or system logs of the operating system to obtain various information related to execution of the application program and stores the obtained information in the behavioral data store 422. The stored information may be processed to generate behavior tokens represent behaviors of the application program at one or more layers of the hardware layer 402, kernel layer 408, application framework layer 410, and application layer 412.

The interface module 424 interacts with the hardware layer 402, the kernel layer 408 the application framework layer 410, and/or the application layer 412 to provide or to obtain information related to execution of application programs. The interface module 424 may access various layers via their respective APIs, memory of the client device 400, and/or system logs of the operating system 426, and the like. The interface module 424 also accesses information related to execution of an application program stored in the behavioral data store 422. For example, the interface module 424 accesses logs, data objects, processes, system calls, parameters, SQL databases for records such as process IDs, parent process IDs, function calls, or parameters, memories, and the like. The interface module 424 may further interact with the analysis application 170 and provide different information to the analysis application 170. In some embodiments, the analysis application 170 interfaces with the interface module 424 for execution of an application program that is stored in the behavioral data store 422. In some embodiments, the interface module 424 accesses the behavioral data store 422 for information related to execution of an application program, generates one or more behavior tokens that represent the application program's behavior at one or more corresponding layers of the application layer 412, application framework layer 410, kernel layer 408, and the hardware layer 402, and provides the generated behavior token to the analysis application 170 for analysis. In one embodiment, the interface module 424 is an API included in a software development kit (SDK) that is included in the operating system 426. When the client device is installed with the analysis application 170, the analysis application 170 can interact with the API as included in the SDK. The interface module 424 may include sub-interfaces that interact with the application layer 412, application framework layer 410, kernel layer 408, and hardware layer 402, respectively.

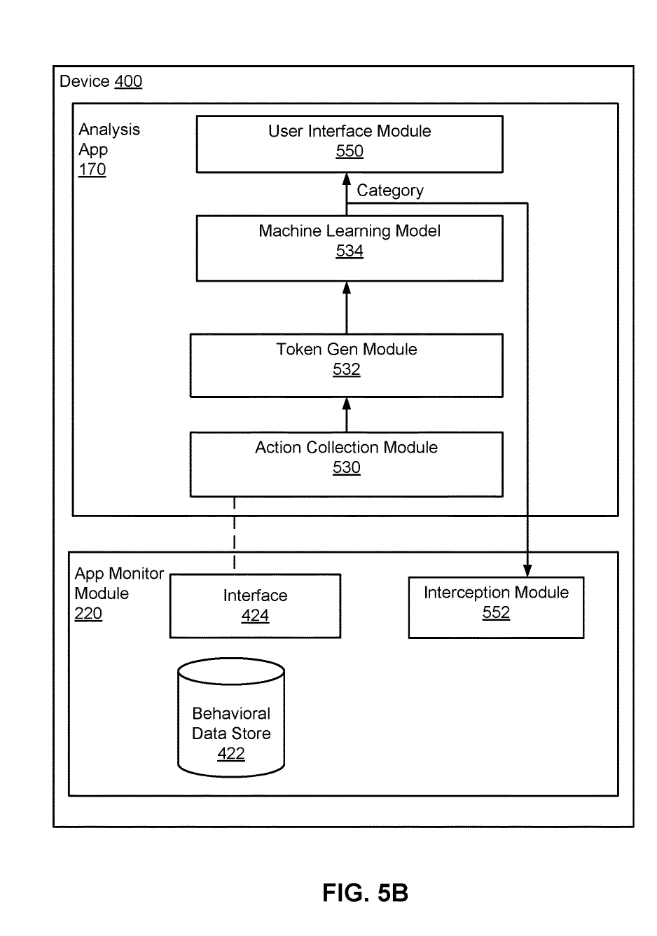

FIGS. 5A-B are high-level block diagrams illustrating detecting security vulnerability as implemented on a client device 400, according to different embodiments. The illustrated client devices 400 can analyze an application program's behavior on the application framework layer thereby to classify an application program. The client device 400 receives an application program package and installs the application program.

That application program package may have been previously analyzed by the analysis system 140 that stores and maintains prior analysis results of application program packages. Each application program package is identified by an application program package ID and associated with a category (e.g., malicious or benign) classified by the analysis system 140. An application program package may be further associated with metadata (e.g., version, release time, etc.). If the application program package ID of the received application program package cannot be located in the list, then it is a new application program package and is further analyzed. In some embodiments, the analysis system 140 distributes the analysis results which are a list of application program package IDs and categories associated with the IDs to client devices 400. The client device 400 queries the application program package ID of the received application program package in the list. If the application program package ID of the received application program package is not included in the list but the client device 400 is online (i.e., communicating with the analysis system 140), the client device 400 provides the application program package to the analysis system 140 for vulnerability analysis.

When the client device 400 is offline (i.e., not communicating with the analysis system 140), the client device 400 categorizes the application programs on-device. The application program executes on the client device 400, and the client device 400 classifies an application program into benign or malicious based on behavioral analysis. The client device 400 analyzes behavior of the application program demonstrated during its execution on the client device 400. Application programs that perform known classes of malicious behavior can be detected and classified as malware. In addition, application programs that perform new types of malicious behavior can also be classified as malware. For example, the new malicious behavior may be similar enough to known malicious behavior that the application program can be classified as malware.

As illustrated in FIG. 5A, the client device 400 includes an application monitor module 420 and an application 170. The application monitor module 420 collects the behavior of the application program at the application framework level and generates a behavior token representing the collected behavior. The application monitor module 420 includes an action collection module 530, a token generation module 532, and an interception module 552. The action collection module 530 collects actions (e.g., function calls) and associated information. Various actions that the application program uses to communicate with the application framework layer 410 are obtained. When an application program executes a command, the application program logs this action in the behavioral data store 424. A particular action is identified by a unique action ID. Parameters and/or payloads that are associated with actions can also be recorded. The action collection module 530 can obtain actions and associated information from the behavioral data store 422 that stores raw behavior data of the application program during its execution.

The token generation module generates behavior tokens. The token generation module 532 processes the collected actions and associated information to generate behavior tokens that can be used by the machine learning model 534 to classify an application program. The behavior tokens include behaviors performed by the application program that may be expected or unexpected. Behaviors that are unexpected may be considered as anomalous behaviors. For example, calling a cipher function followed by calling a transmitting function may be considered anomalous. The token generation module 532 includes the interface module 424 that accesses and processes the actions stored in the behavioral data store 424. A behavior token represents behavior of an application program and includes one or more behavior features that are individual measurable properties of the behavior. A behavior feature includes a sequence of system events performed by an application program. Example behavior features at the application framework layer 410 include actions identified by the unique action IDs, parameters associated with the actions, and payloads associated with the actions. The interface module 424 provides the generated behavior token to the machine learning model 534, which in this example is implemented as part of the analysis application 170.

In this example, the analysis application 170 includes a machine learning model 534 and a user interface module 550. The machine learning model 534 is implemented as part of the analysis application 170. The machine learning model 534 receives the behavior token and classifies the application software into a category (e.g., malicious or benign) based on the behavior features. The machine learning model 534 analyzes behavior features to distinguish benign and malicious action, for example, by identifying which behavioral features or combinations thereof are associated with malicious actions. Details of examples of the machine learning model 534 and its creation and training are previously described with respect to FIGS. 2-3.

When an application program is identified to be malicious, the user interface module 550 generates and presents a user interface to a user. The user may be prompted with a warning message that a particular application program is malicious and should be uninstalled. In addition, when an application program is identified to be malicious, the interception module 552 intercepts the malicious behavior thereby to protect the client device 400 from the attack. For example, the interception module 552 prevents an application program that is identified to be malicious from performing an action. As further explained below, a malicious application program can be identified based on its behavior on different layers. Implementing the interception module 552 on the operating system layer 426 can protect the device 400 from the malicious application's attack as actions are performed (e.g., functions are called) on the operating system layer 426.

FIG. 5B illustrates a different implementation. As illustrated in the example of FIG. 5B, the client device 400 includes an application monitor module 420 and an analysis application 170. The application monitor module 420 includes an interface module 424, a behavioral data store 422, and an interception module 552. An action collection module 530, a token generation module 532, a machine learning model 534, and a user interface module 550 are implemented in the analysis application 170. Compared to the client device 400 illustrated in FIG. 5A where the action collection module 530 and the token generation module 532 reside in the application monitor module 420, the action collection module 530 and the token generation module in FIG. 5B reside in the analysis application 170. In this embodiment, the action collection module 530 interacts with the interface module 424 to obtain various actions during execution of an application program. The token generation module 532 processes the collected actions to generate behavior tokens that can be used by the machine learning model 534 to classify an application program.

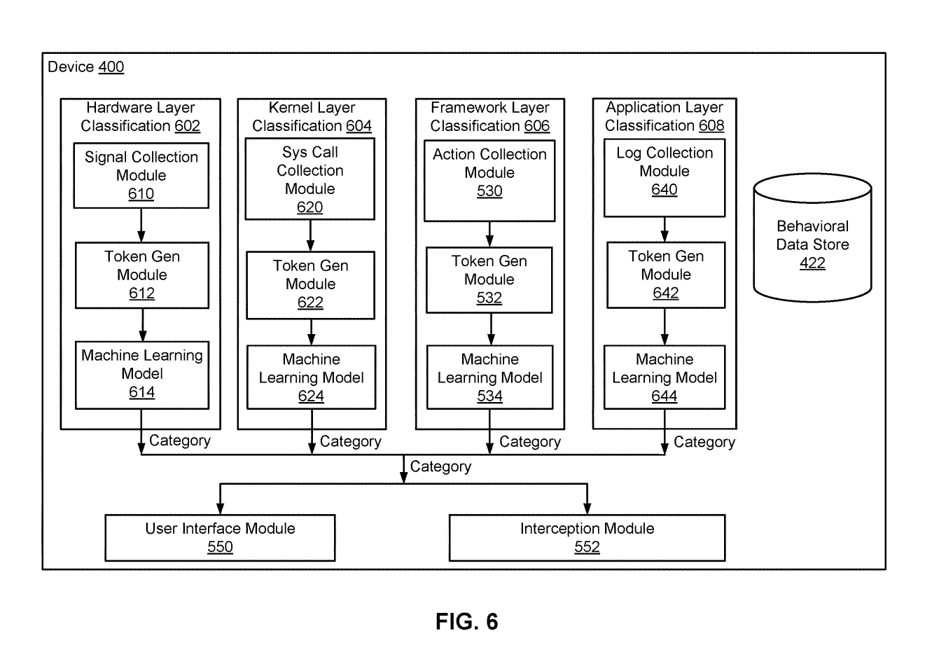

The operating systems of the examples illustrated in FIGS. 5A-B have different instrumentations (i.e., application monitor modules 420). In addition, the analysis application 170 of the examples illustrated in FIGS. 5A-B can also be different. In the example illustrated in FIG. 5A, an application program's behavior at the application framework layer is obtained and processed in the operating system layer 426. The operating system layer 426 includes instrumentation for collecting an application program's behavior and for generating behavior tokens for use by the preprocessor of the machine learning model implemented in the application 170 installed on the device 400. In the example illustrated in FIG. 5B, an application program's behavior at the application framework layer is obtained and processed in the application layer 412. The operating system layer 426 includes instrumentation for collecting an application program's behavior, but it does not generate behavior tokens. The operating system layer 426 interacts with the analysis application 170 installed on the device 400. The analysis application 170 obtains and processes an application program's behavior, generates behavior tokens, and categorizes the application program. The examples illustrated in FIGS. 5A-B detect security vulnerabilities based on application programs' behaviors at the application framework level. The client device 400 can detect security vulnerabilities based on application programs' behaviors on one or more other layers such as the application layers 412, kernel layer 408, and hardware layer 402, as further discussed with respect to FIG. 6.

FIG. 6 is a high-level block diagram illustrating a client device 400 for detecting security vulnerabilities, according to one embodiment. The example client device 400 detects security vulnerabilities based on an application program's behavior on the application, application frame work, kernel, and hardware (including firmware) layers. As such, the client device can detect malicious application programs substantially comprehensively because some anomalous behaviors can be detected typically at some but not at all levels. For example, stealing information typically can be detected at the application framework layer 410 and/or at the hardware layer 402 but not at the kernel layer 408 or at the application layer 412. The client device 400 includes a hardware layer classification module 602, a kernel layer classification module 604, a framework layer classification module 606, and an application layer classification module 608 that each classify the application program based on the application program's behavior at the hardware, kernel, application framework, and application layer, respectively. Behaviors are operations or actions that are performed by the application program as it executes on a client device. Example behaviors include usage of specific objects such as semaphores and mutexes, Application Program Interface (API) calls, memory usages, modification of particular system files, and the like. For example, stack trace dump at the application layer, calling particular functions at the application framework layer, opening file or writing file at the kernel layer, or sending SMSs at the hardware layer are examples of behaviors at different layers. The hardware layer classification module 602, kernel layer classification module 604, framework layer classification module 606, and application layer classification module 608 each use one or more artificial intelligence models, classifiers, or other machine learning models to classify an application using the observed behavior of the application. These models may have been trained and provided by the analysis system 140 as previously described with reference to FIGS. 2-3.

The hardware layer classification module 602, kernel layer classification module 604, framework layer classification module 606, and application layer classification module 608 each observe and monitor behaviors of the application program at different layers and categorize the application program based on the observed behaviors during the application program's execution on the client device 400. That is, each of these layers collects different information related to the behavior of the application program at the corresponding layer and determines whether the observed behavior collection is benign or malicious. Each layer includes a data collection module (e.g., a signal collection module 610, a system call collection module 620, an action collection module 530, or a log collection module 640) that accesses and collects data related to executing behavior such as API calls, system logs, data objects access logs, etc. For example, when an application program that transmits private information without the user's authorization executes on the client device 400, the signal collection module 610 collects signals including a stream of information transmitted at the hardware layer, the system call collection module 620 collects network socket operations at the kernel layer, the action collection module 530 collects the transmitting function call at the application framework layer, the log collection module 640 collects the logs of the application program showing that the private data is transmitted at the application layer.

The signal collection module 610 collects hardware and sensor data such as API calls, wireless signals, inputs and outputs of a chip such as logical values or memory states, side channel signals, etc. The signal collection module 610 may interact with the hardware API (e.g., a chip API made available in the chip SDK) to obtain hardware and sensor signals. The signal collection module 610 identifies the package of the running signal by process information and registers the received signals into memory of the client device 400. The received signals are stored in the behavioral data store 422. In various embodiments, the signal collection module 610 resides in the application monitor module 420.

The system call monitor and collection module 620 obtains a series of system calls (e.g., Android Kernel system calls) that the application program uses to communicate with the kernel layer 408. The system call monitor and collection module 620 may access the memory of the client device 400 to obtain system logs and thereby to collect system calls. Example system calls include special functions or command such as process control, information (e.g., system time, attributes of files and devices) maintenance, communication (e.g., networking, data transfer, attachment/detachment of remote devices), file management, memory management, and device management. A particular system call is identified by a unique system call ID. The system call collection module 620 may be implemented similar to the action collection module 530 as illustrated in FIG. 5A or 5B. The system call collection module 620 may reside in the application monitor module 420 or in the analysis application 170.

The log collection module 640 obtains various application or system logs and messages. The log monitor and collection module 640 may collect log metadata, package names, permissions, activities and services, processes actions (e.g., start, kill), intent and content, debug information levels, URL/file targets, exceptions, and the like. Some of the information may be obtained by processing the application or system logs and messages collected by the log monitor and collection module 640. The collected information is stored in the behavioral data store 422. In various embodiments, the log collection module 640 resides in the analysis application 170.

Each of the hardware layer classification module 602, kernel layer classification module 604, application framework layer classification module 606, and application layer classification module 608 additionally includes a token generation module (e.g., a token generation module 612, 622, 532, or 642) that processes the collected information to generate behavior tokens that can be used by the corresponding machine learning model to classify an application program. The behavior tokens include behaviors performed by the application programs that are expected or unexpected. Unexpected behaviors may be considered as anomalous behaviors. Examples of anomalous behaviors may include unusual network transmissions, accessing storage or APIs to obtain data, impressible access of APIs, unusual changes in performance, circumventing denied location accesses, and the like. The behavior token includes behavior features that are individual measurable properties of behavior of an application. A behavior feature includes at least one behavioral trace that is a sequence of system events performed by an application program. The behavior feature may include the data related to the system events. For example, the behavior feature of uninstalling and installing an application includes events of application scanning, uninstalling, downloading, unzipping, decrypting, and installing, each of which is associated with detailed information such as a source, a file system location, a decryption algorithm, and the like.

In this example, behavior of an application program at each layer is represented by a corresponding behavior token at the layer. A behavior token represents a sequence of behaviors and the associated data and objects. A behavior token may include a data object and a unique behavior ID. A behavior token at the hardware layer includes a number of signal names and parameters associated with the signals. A behavior token at the kernel layer includes system calls and associated parameters and timestamps. The behavior token at the kernel layer may be a large amount of objects. A behavior token at the application framework layer includes actions, parameters associated with the actions, and time stamps associated with the actions. A behavior token at the application layer includes logs with time stamps. As one example, the behavior token may include a sequence for tracing users' private data. If one type of private data is affected, then the sequence is updated accordingly (e.g., a corresponding bit is set to 1). The unique behavior ID identifies a particular behavior. In addition, the attached data comprises information related to objects and/or data (e.g., URL, link, etc.) associated with the particular behavior. The behavior token may be translated into texts describing the application's behavior. A behavior token may further include metadata and parameters associated with actions such as strings, input arguments, local variables, return addresses, system calls, in addition to a binary enumerator denoting a combination of actions. The token generation module 612 or 642 may reside in the analysis application 170 or application monitor module 420. The token generation module 622 may be implemented similar to the action generation module 532 as illustrated in FIG. 5A or 5B. The token generation module 622 may reside in the application monitor module 420 or in the analysis application 170.

Each of the hardware layer classification module 602, kernel layer classification module 604, application framework layer classification module 606, and application layer classification module 608 further includes a machine learning model (e.g., a machine learning model 614, 624, 534, or 644) that classifies the application program into a category (e.g., malicious or benign) based on the behavior tokens. The machine learning models may include, but are not limited to, regression, support vector machine (SVM), decision trees, and neural network classifiers. In one embodiment, the machine learning model 614 is a rule based or expert system based library. In one embodiment, the machine learning model 624 is a linear model. In one embodiment, the machine learning model 644 is a linear model such as a linear SVM or linear regression model.

The machine learning models are trained and provided by the analysis system 140. The machine learning models 614, 624, 534, and 644 each analyze behavior features to identify which behavioral features or combinations thereof can be used to distinguish benign and malicious behaviors. Because different types of information related to the behavior of an application program at the hardware, kernel, application framework, and application layers is collected, the generated behavior tokens that represent an application program's behavior at the hardware, kernel, application framework, and application layers include different features. As a result, the machine learning models 614, 624, 534, and 644 that use behavior tokens including different behavior features that includes different parameters to analyze an application program are different. In addition, the amount of information included in the behavior tokens varies. For example, a behavior token that represents an application program's behavior at the kernel layer and is generated by the token generation module 622 includes more information than a behavior token that represents the application program's behavior at the application (application framework or hardware) layer and is generated by the token generation module 642 (332 or 612). As a result, the speed and/or coverage of machine learning models 614, 624, 534, and 644 in classifying application programs are different. In some embodiments, the machine learning models 614, 644, 624 and 534 are in a descending order of speed in classifying application programs. In some embodiments, the machine learning model 534, 614, 624, and 644 are in a descending order of coverage in classifying application programs.

The analysis system 140 creates machine learning models (e.g., determines the model parameters) by using training data and deploys the trained machine learning models to client devices. The training data includes behavior tokens and the corresponding categories for previously analyzed applications. This can be arranged as a table, where each row includes the behavior token and category for a different application. Using this training data, the analysis system 140 determines the model parameters for a machine learning model that can be used to predict the category of an application. When a client device 400 is online and communicates with the analysis system 140, one or more machine learning models (e.g., model parameters) of the machine learning models 614, 624, 534, and 644 may be updated using the input from the analysis system 140.

The determination of the machine learning models 614, 624, 534, and 644 may be a sliding scale, such as a confidence level that the behavior is either benign or malicious, rather than a binary decision of either benign or malicious. The categorizations from the different classification systems are combined to produce an overall category for the application. For example, in one approach, if a layer classifies the application as malware, then the overall classification is malware. As another example, rules that are based on domain knowledge of mobile security researches are used to resolve conflicting detection results by different layers. Conflicting detection results may be provided to an expert for further analysis where ground truth of the sample can be determined and corrections are made based on the determined ground truth. Details of the user interface module 550 and the interception module 552 are provided with respect to FIGS. 5A-5B.

FIG. 7 is a flow chart illustrating an example process of an analysis system 140 near instantly notifying client devices onto which an application program is installed when the application program is identified to be malicious, according to one embodiment. The analysis system 140 determines 702 that an application program is malicious. The analysis system 140 may determine that an application program is malicious as described with respect to FIGS. 2-3. The analysis system 140 may also determine an application program is malicious by receiving the determination from a client device or a third party. A client device may determine that an application program is malicious as described with respect to FIGS. 4B through 6. The client device may send the determination to the analysis system 140 when online and communicating with the analysis system 140.

The analysis system 140 identifies 704 a set of client devices onto which the application program is installed. For example, the analysis system 140 queries the application program ID of the particular application program in all installation records to identify the installation records that include the application program ID. The installation records that include the application program ID correspond to the client devices onto which the application program is installed. Based on the identified installation records, the analysis system 140 identifies the corresponding client devices' IDs thereby to determine the client devices onto which the particular application program is installed. The set of client device may be identified typically within less than a few minutes after the application program is determined as malicious.

The analysis system 140 broadcasts 706 to the set of client devices that the particular application program is malicious. The analysis system 140 may send SMSs, emails, notifications, and services via analysis applications 170, or other types of warning messages to the set of client devices that the particular application program is malware. Different client devices may be notified differently according to default settings or user preferences. The analysis system 140 may send notifications based on the information (e.g., client device ID or user information (e.g., email address, GMS ID etc.)) associated with the installation records that are determined to include the particular application program ID. The client devices may be notified typically within less than a few seconds after the set of client devices is identified. If one particular client device of the set of client devices is offline and cannot be notified, the analysis system 140 notifies the particular client device when it is online and communicating with the analysis system 140. Based on the received notifications, the set of client devices may notify the users that the particular application program is malicious. For example, the set of client devices may generate and present a user interface (e.g., a pop-up message) such that users are notified that the particular application program is malicious. The users may be prompted with a warning message to uninstall the particular application program. The user interface may be generated by the analysis application 170 as described with respect to FIGS. 5A through 6.

In addition, the client devices may intercept malicious behavior in 708 performed by the particular application program. The client devices may include an instrumentation that prevents an application program from performing one or more actions thereby to protect the client device from the attack. In some embodiments, the instrumentation is configured to prevent the application program from performing all actions or issuing commands. In some embodiments, the instrumentation is configured to prevent the application program from performing suspicious actions and to permit the application program to perform normal actions. As one example, the instrumentation can prevent an application program from sending an SMS by blocking the application program from invoking the sending action in the SMS application, or banning the SMS application directly. As another example, the instrumentation can prevent an application program from writing sensitive data to an unsafe or unauthorized section of the storage by blocking the write function call. As a further example, the instrumentation can prevent an application program from stealing private data from a private folder of the user's contact application and transmitting to an FTP server in internet by blocking one or more network packets that includes the private data, or can prevent an application program from dynamically loading a library when that is identified to be malicious. In various embodiments, the instrumentation is implemented on the operating system layer such that the instrumentation can intercept substantially all actions. The operating system implemented with the instrumentation is previously described with respect to FIGS. 4B through 6.

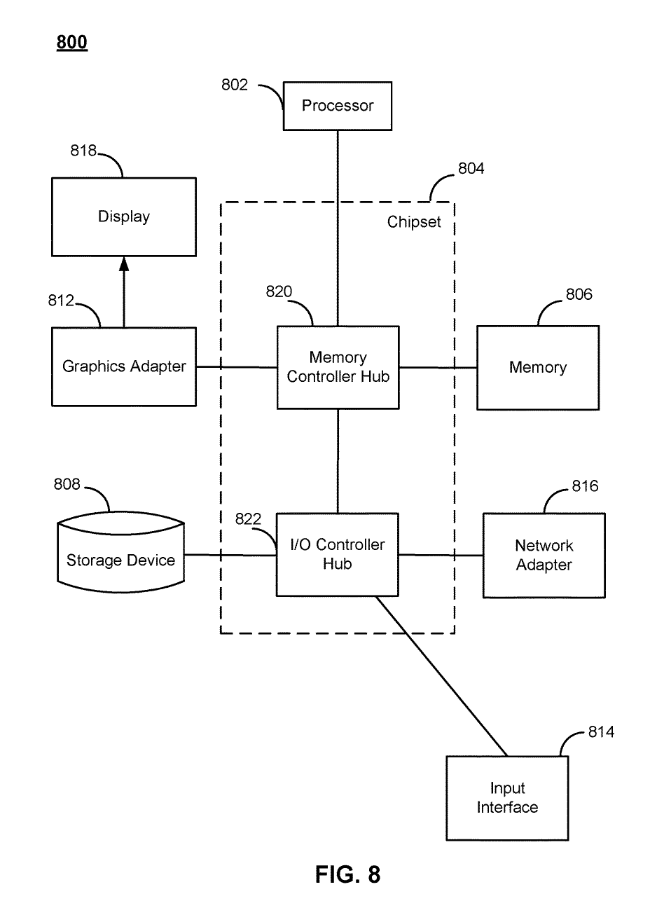

FIG. 8 is a high-level block diagram illustrating an example computer 800 for implementing the entities shown in FIG. 1. The computer 800 includes at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, an input device 814, and network adapter 816 are coupled to the I/O controller hub 822. Other embodiments of the computer 800 have different architectures.

The storage device 808 is a non-transitory computer-readable storage medium such as a hard drive, compact disk read-only memory (CD-ROM), DVD, or a solid-state memory device. The memory 806 holds instructions and data used by the processor 802. The input interface 814 is a touch-screen interface, a mouse, track ball, or other type of pointing device, a keyboard, or some combination thereof, and is used to input data into the computer 800. In some embodiments, the computer 800 may be configured to receive input (e.g., commands) from the input interface 814 via gestures from the user. The graphics adapter 812 displays images and other information on the display 818. The network adapter 816 couples the computer 800 to one or more computer networks.

The computer 800 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 808, loaded into the memory 806, and executed by the processor 802.

The types of computers 800 used by the entities of FIG. 1 can vary depending upon the embodiment and the processing power required by the entity. For example, the media service server 130 can run in a single computer 800 or multiple computers 800 communicating with each other through a network such as in a server farm. The computers 800 can lack some of the components described above, such as graphics adapters 812, and displays 818.

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

The above description is included to illustrate the operation of certain embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A computer-implemented method for protecting mobile devices against malware, comprising:
determining, by an analysis system, that an application program is malicious;
identifying, by the analysis system, a set of client devices onto which the application program is installed; and
notifying, by the analysis system, the set of client devices that the application program is malicious.

2. The computer-implemented method of claim 1, wherein the step of identifying the set of client devices comprises:
identifying, by the analysis system, a set of installation records that include the application program ID of the application program, wherein each installation record includes a device ID of a client device and application program IDs for application programs installed on the client device; and
determining, by the analysis system, a set of device IDs included in the set of identified installation records.

3. The computer-implemented method of claim 1, wherein an analysis application is installed on at least some of the client devices, and the step of notifying the set of client devices comprises sending, by the analysis system, a notification to the analysis applications installed on the set of client devices that the application program is malicious.

4. The computer-implemented method of claim 3, wherein the analysis application causes the client device to, in response to the received notification, generate and present a user interface notifying a user that the application program is malicious.

5. The computer-implemented method of claim 3, wherein the analysis application causes the client device to, in response to the received notification, prevent the application program from performing an action.

6. The computer-implemented method of claim 2, further comprising:
creating, by the analysis system, a plurality of installation records for client devices, wherein the set of installation records are identified from the plurality of installation records; and
maintaining, by the analysis system, the plurality of installation records based on installation information received from the client devices, comprising:
responsive to the installation information indicating that a first application program has been installed on the client device, including the first application in the installation record for that client device; and
responsive to the installation information indicating that a second application program has been removed from the client device, removing the second application from the installation record for that client device.

7. The computer-implemented method of claim 6, wherein an analysis application is installed on the client device, and the analysis application causes the client device to send the installation information to the analysis system responsive to installing the first application program and responsive to uninstalling the second application program.

8. The computer-implemented method of claim 1, wherein the step of determining the application program as malicious comprises:
receiving an application package corresponding to the application program configured for installation on a client device;
executing the application package on an instrumented simulation engine for the client device;
recording which behaviors from a set of behaviors occur during execution of the application package; and
categorizing the application package as benign or malicious based on which behaviors occurred during execution of the application package.

9. The computer-implemented method of claim 1, wherein the step of determining the application program as malicious comprises receiving from a client device that the application program is malicious, wherein the client device is configured to and includes an instrumentation for recording behavior of the application program during execution:
execute the application program;
record a set of behaviors of the application program during execution, the set of behaviors including at least one of an application layer behavior, an application framework behavior, a kernel layer behavior, and a hardware layer behavior; and
categorize the application program as benign or malicious based on the set of behaviors recorded.

10. A computer program product for protecting mobile devices against malware, the computer program product comprising a non-transitory machine-readable medium storing computer program code for performing a method, the method comprising:
determining, by an analysis system, that an application program is malicious;
identifying, by the analysis system, a set of client devices onto which the application program is installed; and
notifying, by the analysis system, the set of client devices that the application program is malicious.

11. An analysis system for protecting mobile devices against malware, comprising:
a processor; and
non-transitory machine-readable medium storing instructions configured to cause the processor to perform:
determining that an application program is malicious;
identifying a set of client devices onto which the application program is installed; and
notifying the set of client devices that the application program is malicious.

12. The analysis system of claim 11, wherein the step of identifying the set of client devices comprises:
identifying a set of installation records that include the application program ID of the application program, wherein each installation record includes a device ID of a client device and application program IDs for application programs installed on the client device; and
determining a set of device IDs included in the set of identified installation records.

13. The analysis system of claim 11, wherein an analysis application is installed on at least some of the client devices, and the step of notifying the set of client devices comprises sending a notification to the analysis applications installed on the set of client devices that the application program is malicious.

14. The analysis system of claim 13, wherein the analysis application causes the client device to, in response to the received notification, generate and present a user interface notifying a user that the application program is malicious.

15. The analysis system of claim 13, wherein the analysis application causes the client device to, in response to the received notification, prevent the application program from performing an action.

16. The analysis system of claim 12, wherein the instructions are configured to cause the processor to further perform:
creating a plurality of installation records for client devices, wherein the set of installation records are identified from the plurality of installation records; and
maintaining the plurality of installation records based on installation information received from the client devices, comprising:
responsive to the installation information indicating that a first application program has been installed on the client device, including the first application in the installation record for that client device; and
responsive to the installation information indicating that a second application program has been removed from the client device, removing the second application from the installation record for that client device.

17. The analysis system of claim 16, wherein an analysis application is installed on the client device, and the analysis application causes the client device to send the installation information to the analysis system responsive to installing the first application program and responsive to uninstalling the second application program.

18. The analysis system of claim 11, wherein the step of determining the application program as malicious comprises:
receiving an application package corresponding to the application program configured for installation on a client device;
executing the application package on an instrumented simulation engine for the client device;
recording which behaviors from a set of behaviors occur during execution of the application package; and
categorizing the application package as benign or malicious based on which behaviors occurred during execution of the application package.

19. The analysis system of claim 11, wherein the step of determining the application program as malicious comprises receiving from a client device that the application program is malicious, wherein the client device is configured to and includes an instrumentation for recording behavior of the application program during execution:
execute the application program;
record a set of behaviors of the application program during execution, the set of behaviors including at least one of an application layer behavior, an application framework behavior, a kernel layer behavior, and a hardware layer behavior; and
categorize the application program as benign or malicious based on the set of behaviors recorded.
